(19) United States
(12) Patent Application Publication
(10) Pub. No.: US 2004/0195476 A1
(43) Pub. Date: Oct. 7, 2004

(54) Support pole attachment collar

(76) Inventor: Richard Gouley, Bellevue, ID (US)

Correspondence Address: DEREK H. MAUGHAN, DYKAS, SHAVER & NIPPER, LLP, PO BOX 877, BOISE, ID, 83701-0877, US

(21) Appl. No.: 10/801,749

(22) Filed: Mar. 15, 2004

Related U.S. Application Data
(63) Continuation-in-part of application No. 10/668,388, filed on Sep. 22, 2003.
Application No. 10/668,388 is a continuation-in-part of application No. 10/409,465, filed on Apr. 7, 2003, now abandoned.

(51) Int. Cl. G11B 5/147

(52) U.S. Cl. 248/200.1

(57) ABSTRACT

A vertical support pole having an improved surface contacting head for use in holding devices in desired positions and orientations. The support pole has a first end and a second end and compressible head located near the first end of the pole. The head has a surface-contacting portion and a portion configured to interact with a compression device located within the support pole. A flared collar extends from the first end of the pole. This flared collar has a plurality of projections that are configured to extend around the head and spread outward when a sufficient quantity of force is applied to the head. This specially designed head allows the support pole to contact a greater number of points across a greater surface area and provide increased support of the load or surface being contacted by the head.

### PRIORITY

This application is a Continuation-in-Part of U.S. patent application Ser. No. 10/668,388 filed Sep. 22, 2003 which is a Continuation in Part of U.S. patent application Ser. No. 10/409,465 filed Apr. 7, 2003, the contents of both of these applications are hereby incorporated by reference.

### BACKGROUND OF THE INVENTION

1. Field of the Invention

The present invention generally relates to a low-cost, simplified universal support suspension pole, and more particularly to a connection device for such a pole. More particularly, and by way of example and not limitation, the invention is directed to a supportive pole, having spring suspension, for use in construction environments to buttresses material for draping and partitioning rooms, doorways and the like to protect surfaces and objects from debris. The device may also be used to buttresses bricks, tile, stone, drywall, and other surfaces, as well as temporary walls when necessary. The universal supportive suspension pole has simplified construction to reduce the manufacturing time and material costs and is affordable to the average consumer.

2. Background Information

Information some commercial and residential construction environments, such as new building construction or interior remodeling to protect walls, stairways, doors, rooms and objects from potential damage, in a simple and affordable manner. It is further desirable in some construction environments to support bricks, stone, drywall and other objects against surfaces while a bonding agent cures. Additionally, it is desirable in some construction environments to support temporary walls and doors when adhesives and nails are not suitable for supporting such a temporary wall or surface.

In common practice, barrier sheeting is supported for shielding objects from dust and debris caused by construction activities. Some methods of supporting barrier sheeting include taping, gluing and stapling the barrier sheeting to items such as walls, fixtures and other objects. These techniques, though low cost, are time consuming and often damage the attachment structure by leaving adhesive residue or holes. Another method of supporting barrier sheeting uses an elaborate pole mechanism having spring loaded feature comprising a piston, cylinder, and a spring assembly made from numerous specialty parts using expensive fabrication techniques, such as molding and machining. See, for example Whittemore (U.S. Pat. No. 6,508,295). Though these devices are effective in supporting barrier sheeting, they are expensive to buy and difficult to manufacture. The cost of manufacturing these elaborate pole mechanisms includes expensive molds for injection molding and complicated assembly processes which contribute to an expensive product to the consumer.

When it is desirable to secure bricks, stones, drywall and other objects overhead using bonding or adhesive methods, in common practice, objects are supported for securing using cumbersome scaffolding techniques or manual labor to hold and object in place until the bonding material has sufficiently cured. Also, at times a temporary wall must be supported when nails and adhesives are not desirable, for example when a door has been removed from a doorway surrounded with ornamental trim, in common practice, a host of objects are rested against a temporary wall to hold the wall against the doorway.

What is needed is a low cost, simple universal supportive pole, with suspension operation, and a surface interface that is easy to make and use, and which provides for increased barrier impermeability. The present invention was developed in an effort to provide an effective low cost, simple universal supportive pole and surface support with suspension operation that is easy to make and use.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a vertical support pole having an improved surface contacting head that is used in systems that utilize a temporary support system to hold devices in desired positions and orientations and particularly in desired vertical positions and orientations. The device is comprised of a support pole having a first end and a second end, with a head located near the first end of the pole. The head has a surface-contacting portion and a portion configured to interact with a compression device located within the support pole. The compression device is comprised of a device such as a spring that provides resistance to the compression of the head and exerts a force against the head so as to push the head against a surface. A flared collar extends from the first end of the pole. This flared collar has a plurality of projections that are configured to extend around the head and spread outward when a sufficient quantity of force is applied to the head.

This feature allows the support pole to contact a greater number of points across a greater surface area and provide increased support of the load or surface being contacted by the head. This head also provides a more simple use than is found in other similar devices and provides for better seals between a piece of sheeting and a support surface that the support pole is positioned against.

The purpose of the foregoing abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a perspective view of the present invention.

FIG. 2 is a perspective view of the flexible flanged collar shown in FIG. 1

FIG. 3 is a perspective detail view of the surface-contacting head.

FIG. 4A is a perspective view of a prior art device shown holding a piece of plastic sheeting in place.

FIG. 4B is a perspective view of the present invention shown holding a piece of plastic sheeting material in place.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

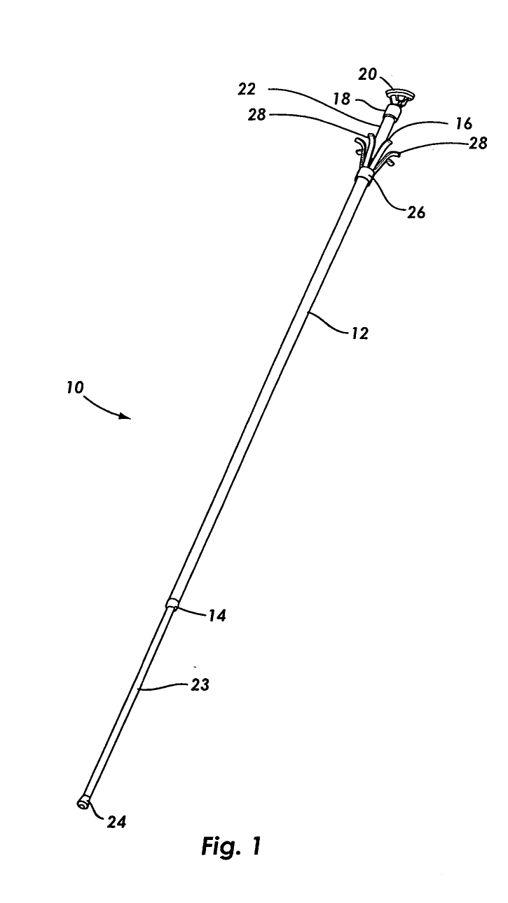

FIGS. 1-3 and 4B show various embodiments of the present invention. Referring first to FIG. 1 a perspective view of the present invention is shown. The present invention utilized in conjunction with a housing pole 12 having a first end 16 configured to receive a first compressible pole 22 therein. The housing pole 12 extends from this first end 16 to a second end 14. The second end 14 of the pole is configured to receive a second extendible inner pole 23. This extendible inner pole 23 extends to a foot 24. The extendible inner pole 23 is held in a desired position by various locking devices (shown in parent applications) that are positioned within the housing pole 12. These locking devices allow the position and the length of the combination of the extendible inner pole 23 and the outer housing pole 12 to be varied according to the necessities of the user. A more complete description of this pole locking system is found in the parent patent application, U.S. application Ser. No. 10/409,465, filed by the same inventor on Apr. 7, 2003, the contents of which have been previously been incorporated by reference into this application.

A surface contacting head 18 extends from the first compressible pole 22, which is configured for compressible insertion within the housing pole 12. A spring (not shown) sits beneath this first compressible pole 22 (also referred to as the top pole) and provides the first compressible pole 22 with the ability to be compressed into the housing pole 12. This spring also provides selectively adjustable force upward against the top pole 22 and thus exerts force by the head 18, against a designated surface through a surface-contacting portion 20. The surface-contacting portion 20 has a cover 30, which prevents the surface against which the device is placed from head from marking or being inserted within that surface. This cover 30 thus protects the surface as well as other materials that may come into contact with the surface contacting portion 20 of the head. In the preferred embodiment a universal type of joint connects the surface contacting portion 20 to the head 18 and allows for placement of the surface contacting portion 20 against the varied multiply oriented surfaces. A detailed perspective view of this head portion 18 is shown in FIG. 3 of the present application.

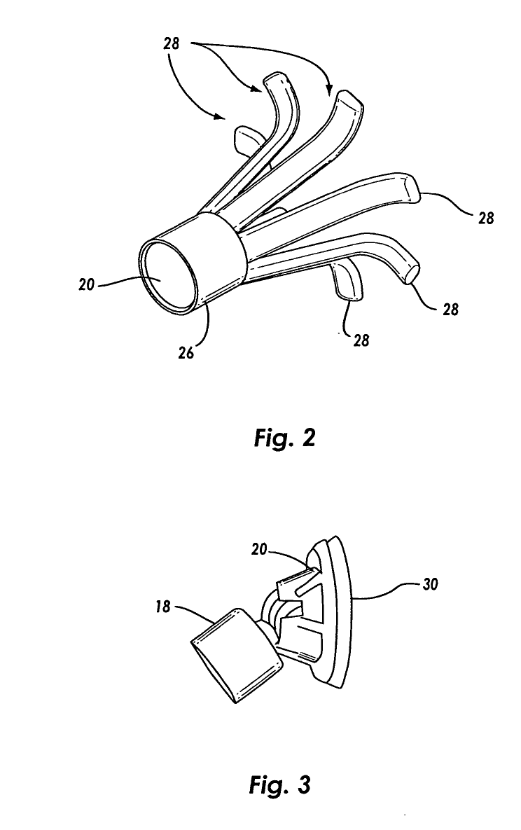

Attached to the housing pole 10 near its first end 12 is a flared collar 26. This flared collar 26 contains a plurality of flexible flanges or projections 28, which extend in a circumvolving pattern around the entire collar 26 and around the top pole 22 and head 18. A detailed perspective view of this embodiment of the invention is shown in FIG. 2. The number of flanges 28 depends upon the actual necessities of the user, but it in the preferred embodiment at least 6 flanges are present. In the preferred embodiment the flanged collar 26 and the projections 28 that extend from the collar 26 are made of the same material. However, it is to be distinctly understood that the invention is not limited thereto but may be variously configured to have various parts made from various types of materials. In the preferred invention these projections 28 are made of a flexible materials which flatten as increased force against the collar is transmitted. This flattening and spreading of the flanges 28 causes the quantity of interaction between the flanges and a surface to be increased. This then translates to increased abilities of the flanges 28 to hold a flexible device such as a piece of sheeting against a surface.

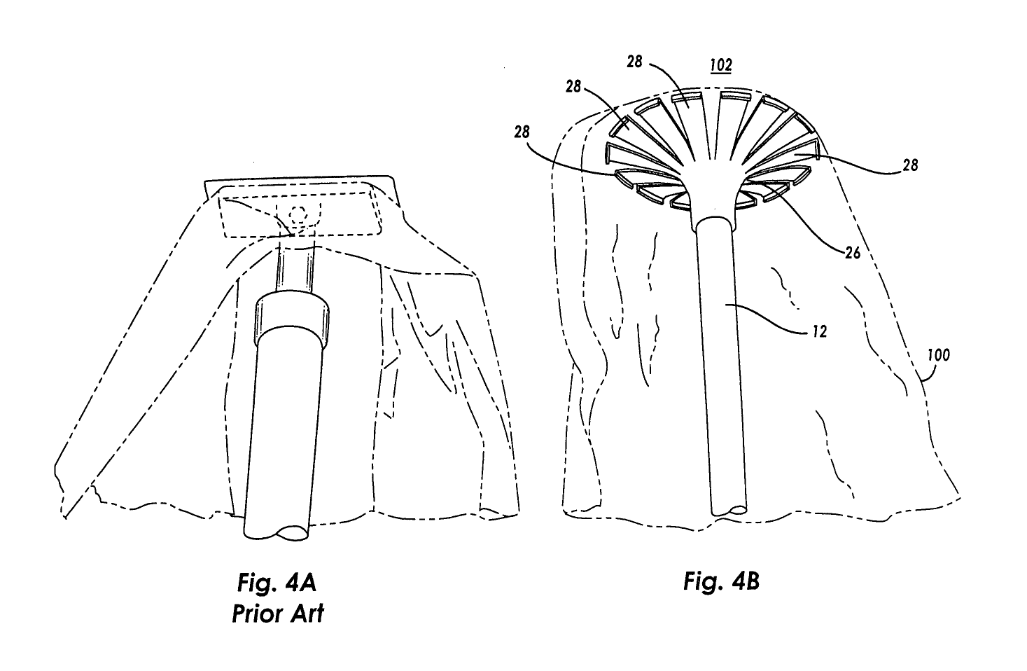

FIG. 4A shows a prior art invention in use holding a piece of plastic against a surface. FIG. 4B shows the flanged collar of the present invention in use holding piece of plastic sheeting 100 up against a surface 102. In this figure the head (not shown) has been placed in a designated position up against the plastic sheeting 100 and the remaining portions of the support pole 12 have been appropriately configured to provide a desired amount of force against the surface. As the amount of force exerted by the housing pole 10 increases, the flanges 28 of the flared collar 26 extend generally radially outward from the central portion of the collar 26. As these flanges 28 extend outward and flatten, greater quantities of the plastic sheeting 100 are contacted and pressed up against the surface 102. This then causes the plastic sheeting to be pushed tightly against a designated surface.

This configuration shown in FIG. 4B provides a significant advantage over the prior art devices such as those shown in FIG. 4A, which utilize a sandwich type design to hold pieces of plastic sheeting in place. These prior art sandwich type designs hold the sheeting between two portions of the head attachment device and then the head attachment device is hoisted up against the surface. In these prior art embodiments a space exists between the surface and the plastic sheeting and as a result vapors, dust and spray will escape from the area of desired containment. The present invention with the flared collar provides a tight connection directly between the plastic sheeting and the surface against which the plastic is placed. This tighter connection provides better sealing capabilities and decreases the amount of materials that escape from the desired area of containment. This configuration also provides other significant advantages in that it is much cheaper to manufacture and ship, and easier to use then those devices found in the prior art.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. In a temporary support suspension system having a pole with a compressible head, a surface contacting device comprising:
a flared collar extending from a portion of said pole proximate to said head, said flared collar having a plurality of projections extending therefrom, said projections configured to circumvolve said head and engage a portion of said surface when said projections are pushed against said surface.

2. The surface contacting device of claim 1 wherein said flared collar is positioned closer to a first end of said pole than said head when said head in an uncompressed position.

3. The surface-contacting device of claim 1 wherein said flared collar is made of a flexible material whereby said projections bend outward from said collar when said pole is pushed against said surface.

4. The surface-contacting device of claim 1 wherein said head has a covering configured to prevent damage to said surface.

5. The surface-contacting device of claim 1 wherein said flared collar comprises a portion configured to engage and hold a piece of non-rigid material against said surface.

6. The surface contacting device of claim 1 wherein said flared collar is a generally coronate shaped piece of flexible material connected around a pole in a position lower than said head when said head is in an uncompressed position.

7. The surface-contacting device of claim 1 wherein said flared collar comprises at least six flanges.

8. The surface contacting device of claim 1 wherein said flared collar compression device is permanently connected to said pole.

9. The surface contacting device of claim 1 wherein said flared collar compression device is removably connected to said pole.

10. A suspension system for suspending a curtain comprising:
a pole having a first end and a second end said pole having a longitudinal axis;
a head having an upper first engaging surface extending parallel to said longitudinal axis, said head coupled to a compressive mechanism near said first end of said pole;
said compressive mechanism configured to allow said head to be compressed toward said second end of said pole; and
a generally coronate shaped collar surrounding said head, said generally coronate shaped collar configured to engage a portion of a surface when said head is compressed toward said second end.
